(19) United States
(12) Patent Application Publication
(10) Pub. No.: US 2007/0039437 A1
(43) Pub. Date: Feb. 22, 2007

(54) SYSTEM FOR CUTTING AND WRAPPING THERMOPLASTIC MATERIALS

(76) Inventors: Andrew James Lineberry, Bailey, CO (US); Michael William Tobin, Bozeman, MT (US)

Correspondence Address: BLACKWELL SANDERS PEPER MARTIN LLP, 4801 Main Street, Suite 1000, KANSAS CITY, MO, 64112, US

(21) Appl. No.: 11/161,857

(22) Filed: Aug. 19, 2005

(51) Int. Cl. B26D 1/553

(52) U.S. Cl. 83/16; 83/651.1; 83/171

(57) ABSTRACT

A system for cutting and wrapping blocks of synthetic material enables a material block to be pre-cut into a form substantially ready to be used as packaging filler while maintaining the original compact block shape for shipping and storage. In one aspect, the system takes synthetic material blocks, such as thermoplastic blocks, and sequentially drives the blocks through a cutting mechanism that cuts the blocks in two directions to form thermoplastic strips. The thermoplastic strips are held together in the original geometric form of the block through the cutting process, and thereafter a rotating wrapper applies a wrapping material to the pre-cut thermoplastic block secure the pre-cut block in the original geometric form. A block or log magazine sequentially positions multiple synthetic material blocks prior to being driven through the cutting mechanism.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

Various materials have been used as packaging filler to provide stability and cushioning to items during shipment and handling. One common class of filler materials is synthetic materials. More specifically, thermoplastic materials are a preferred type of synthetic material for use as packaging filler. Thermoplastic filler materials frequently include expanded molded or extruded polystyrene, polystyrene/polypropylene compounds, polystyrene/polyethylene compounds, or other similar materials, and may take the form of a large continuous piece (or set of pieces) specifically shaped to surround a packaged item. Alternatively, thermoplastic filler material make take the form of small pellets or pieces having a variety of shapes, such as those commonly referred to as “peanuts” or other forms such as rounded shell-shaped pieces, “M” or “S” shaped pieces, etc. Because of the small size of the thermoplastic pieces, a box filled with the pieces will posses a latticework of supporting thermoplastic material. In this way, the filler pieces can inhibit the movement of an item placed in the box, as well as cushion the items against sharp blows to the box.

The inventors of the present application have found that one thermoplastic material configuration that is particularly useful in protecting items during shipping is an elongated pellet in the shape of a wave or sinusoidal waveform (hereinafter called a “wave pellet”), as described in U.S. Pat. No. 5,992,633 (the '633 patent), issued to Burchard. This type of configuration causes interlocking between adjacent wave pellets to essentially fix the position of an item placed in a package filled with the pellets. The inventor in the '633 patent validated this principle through a vibration test and a displacement or “drop” test.

More widespread use of thermoplastic wave pellets would be achieved if manufacturing processes for the pellets is simplified. For example, the '633 patent teaches the use of an electronically heated harp to make a first cut in a wave pattern to a thermoplastic material block. To make a second cut forming the block into elongated strips, the block must be rotated 90 degrees about its longitudinal axis and moved to a second cutting machine for cutting the block in a horizontal direction. Finally, the block in the form of elongated strips generated from the first and second cuts is moved to a third cutting machine where a transverse cut perpendicular to the longitudinal axis is made to form the block into the final pellet product having a sinusoidal waveform. If the block has more than a minimal length, rotation of the block as described in the patent requires significant space on the floor of a manufacturing facility, and a complex machine and/or human effort may be needed, to accomplish such rotation. Additionally, having to move the pre-cut block two times between the time the first cut and the third cut are made increases the chances that the block will not be cut in a way as to yield uniform wave pellet, and increases the difficulty in retaining the pre-cut block in its original geometric form before it can be packaged for shipment. Keeping the block cut into the pellets in its original geometric square or rectangular form makes it easier to ship the block where it can be used because it is less bulky than shipping a bag or other container of loose pellets. At the same time, manufacturers are often reluctant to expend significant effort to try and retain the original geometric form of the pre-cut block.

### BRIEF SUMMARY OF THE INVENTION

A system for cutting and wrapping blocks of synthetic material, such as thermoplastic material used as packaging filler, is provided. This system simplifies both the fabrication of pre-cut thermoplastic blocks having cuts in at least two directions to form the blocks into a series of elongated strips, and the packaging of the pre-cut blocks to maintain the original compact geometric form of the block.

In one aspect, the system takes thermoplastic blocks (e.g., in the form of elongate logs) and drives the blocks through a cutting mechanism that cuts the blocks in two directions to form thermoplastic strips. The thermoplastic strips are held together in the original geometric form of the block through the cutting process, and thereafter a rotating wrapper applies a plastic film to the pre-cut block to secure the pre-cut blocks in the geometric form. A block or log magazine may be provided to sequentially position multiple blocks prior to being driven through the cutting mechanism.

In another aspect, the cutting mechanism includes both an oscillating cutting harp having a series of parallel arranged electrically heated wires and a second stationary cutting harp having a series of parallel arranged electrically heated wires perpendicular to the wires of the oscillating cutting harp. The thermoplastic block is driven through the first cutting harp oscillating in an up and down motion to cut the block into vertically stacked layers having a sinusoidal waveform, and then encounters the second cutting harp which cuts the stacked layers to subdivide the layers longitudinally into waveform strips. The waveform strips thereby make up a “pre-cut” form of the thermoplastic block that upon being cut vertically outside of the cutting mechanism, form the wave pellets.

In still another aspect, subsequent to moving through the cutting mechanism, the system continues to drive the pre-cut block in the form of narrow waveform strips through a rotating wrapper (e.g., a strap wrapper). The rotating wrapper may take the form of a rotating ring and wrapping material roll supporting arms. The ring rotates on a frame of the system and has an open central region through which the pre-cut block is driven. The support arms extend from the ring and hold rolls of wrapping material that are dispensed as a film onto a pre-cut block as the block is driven through the ring and the ring rotates, and thereby wrap around the block to secure the waveform strips together and maintain the original geometric form of the block. Preferably, the support arms for dispensing the rolls of wrapping material are at diametrically opposed positions on the rotating ring so that the dispensed wrapping material compresses the pre-cut block at opposed locations, thereby balancing the compressive forces to minimize distortion of the block and facilitate maintaining the original geometric form of the block while the wrapping is being applied.

### BRIEF DESCRIPTION OF THE SEVERAL VIEWS OF THE DRAWING

FIG. 1 is a perspective view of the cutting and wrapping system of the present invention;

FIG. 2 is a partial broken view of the housing of the cutting and wrapping system showing the first and second cutting harps;

FIG. 3 is a side elevational view of the cutting and wrapping system with the housing removed to reveal the components of the driving mechanism;

FIG. 4 is a perspective view of one pre-cut Thermoplastic block formed by the cutting mechanism of the system;

FIG. 5 is a schematic block diagram of the control unit;

FIG. 6A is a close-up view of the block indexing mechanism where the support bar holds the Thermoplastic block at a first position; FIG. 6B is a close-up view of the block indexing mechanism where the support bar is at a second position where the Thermoplastic block is released;

FIG. 7 is a perspective view of the system of FIG. 1 with Thermoplastic blocks loaded into the block magazine;

FIG. 8 is a front view of the wrapping mechanism applying strap wrapping to the Thermoplastic block; and

FIG. 9 is an exploded view of the cutting mechanism showing the first and second cutting harps.

### DETAILED DESCRIPTION OF THE INVENTION

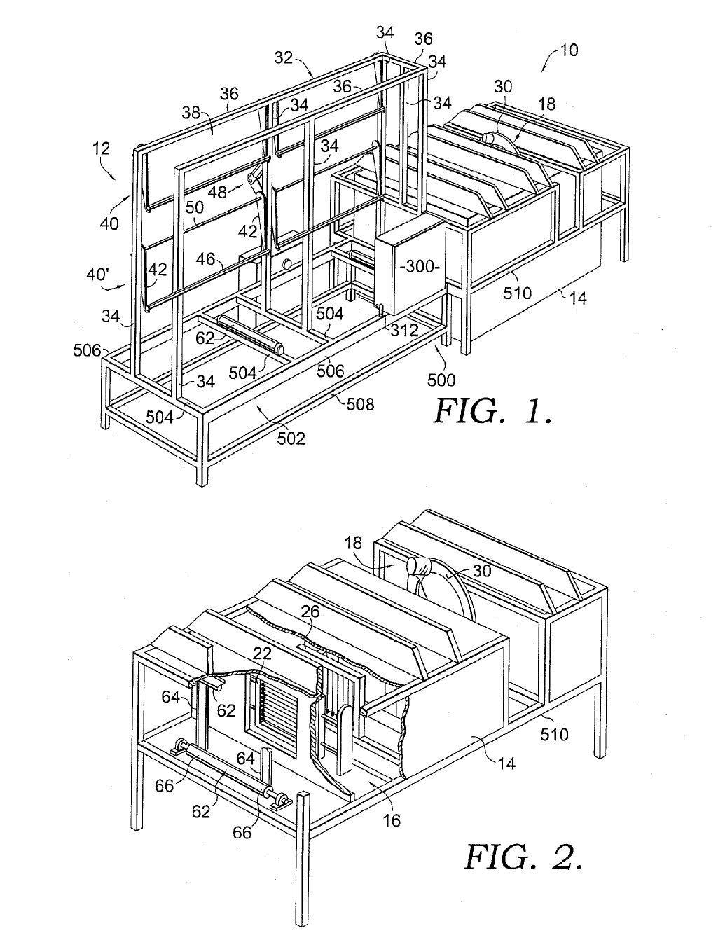

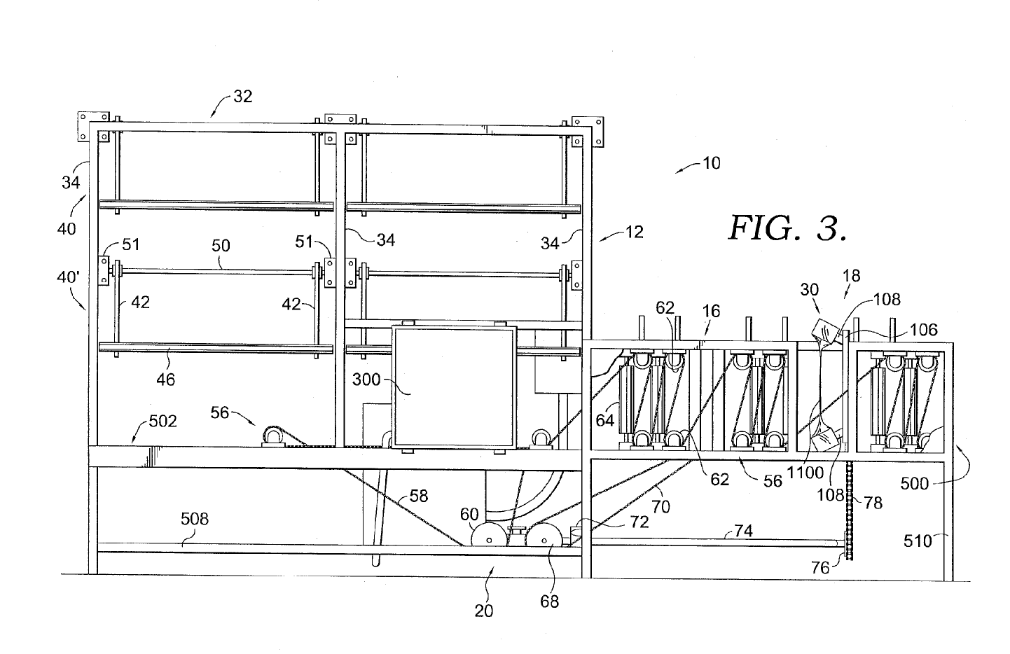

With specific reference to the several views of the drawing, where like numerals designate like elements, there is shown in FIG. 1 a cutting and wrapping system 10 for a synthetic material, preferably for logs or blocks of thermoplastic material expanded 1000 that may be used as packaging filler for storage or shipment of items in a container. Such thermoplastic material may include, for instance, expanded molded or extruded polystyrene, polystyrene/polypropylene compounds, polystyrene/polyethylene compounds. Regardless of the type of synthetic material, the blocks to be handled by the system 10 should be of a material that can be cut efficiently by heated wires, as will be more fully explained below. The system 10 includes a block magazine 12 for sequentially positioning of thermoplastic blocks 1000, a housing 14 within which is located, as shown in FIG. 2, a cutting mechanism 16 for cutting the Thermoplastic block 1000 into sections, a wrapping mechanism 18 for wrapping the pre-cut block sections such that the pre-cut block is retained in substantially the same geometric form as the original uncut block, and, as shown in FIG. 3, a driving mechanism 20 to feed the Thermoplastic blocks 1000 into the cutting mechanism 16 and drive the blocks therethrough and through the wrapping mechanism 18.

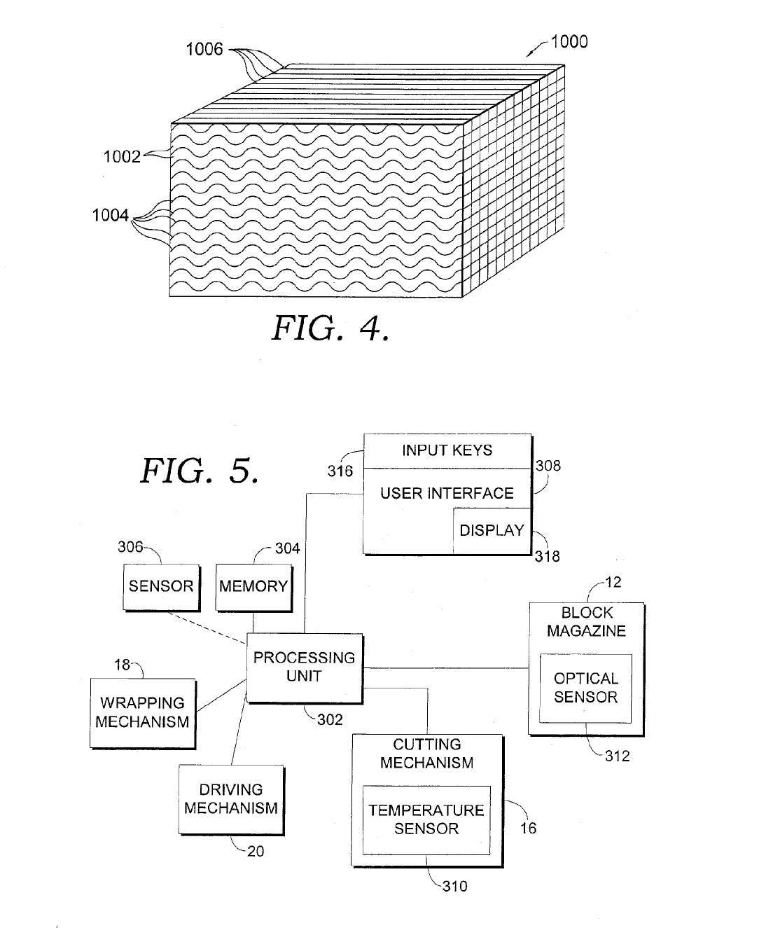

In one embodiment of the system 10, the cutting mechanism 16 comprises a first cutting harp 22 and a second stationary cutting harp 26. The first cutting harp 22 has generally equally spaced and parallel horizontally-oriented electrically heated wires 24 and oscillating in the vertical plane to form a first cut in the thermoplastic block 1000 as the block is driven therethrough. The second stationary cutting harp 26 has generally equally spaced and parallel vertically-oriented electrically heated wires 28 to form a second cut in the thermoplastic block 1000 driven therethrough, generally forming the now “pre-cut” block into a series of elongated waveform strips 1002, as shown in FIG. 4. Additionally, the wrapping mechanism 18 comprises a rotating wrapper 30 that circulates around the thermoplastic block 1000 cut by the cutting mechanism 16 into the waveform strips 1002 and dispenses wrapping film or the like (e.g., plastic sheet film) onto and surrounding the pre-cut block 1000.

With the system 10 of the present invention, the pre-cut and wrapped block can easily be moved to another machine for further sectioning thereof, or can be moved or otherwise shipped to another location where the block can later be disassembled into the respective sections and used as packaging filler. Although the waveform strips are shown in FIG. 4 to take on a sinusoidal waveform, other exemplary shapes may be chosen utilizing an oscillating and a stationary cutting harp. The various components of the system 10 may be mounted onto a flame 500 such that the system 10 is formed as an integrated unit.

FIG. 5 schematically illustrates electromechanical operation of the cutting and wrapping system 10. A control unit 300 includes a processing unit 302 (e.g., microprocessor and logic circuitry) for controlling the operation of one or more of the block magazine 12, the cutting mechanism 16, the wrapping mechanism 18, and the driving mechanism 20, and internal system memory 304 (e.g., EEPROM) coupled with, or integrated into, the processing unit 302 and upon which is stored an application program to control operation of the block magazine 12, the cutting mechanism 16, the wrapping mechanism 18 and the driving mechanism 20 based upon data received from various sensors 306 and user interface 308. In one exemplary arrangement, a temperature sensor 310 measures the temperature of the electrically heated wires 24, 28 of the first and second cutting harps, 22, 26, respectively (see FIG. 9), to ensure that the wires can efficiently cut through the Thermoplastic block 1000 driven therethrough. In another exemplary arrangement, an optical sensor 312 determines whether one thermoplastic block 1000 has been fully fed a certain amount into the cutting mechanism 16 (i.e., by sensing whether a block is in the optical path of the sensor 312) and if so, the processing unit 302 commands the block magazine 12 to position one thermoplastic block 1000 for feeding into the cutting mechanism 16. The temperature sensor 310 and/or the optical sensor 312 may provide data to the processing unit 302 through an analog-to-digital (A/D) converter (not shown) if the sensors drive an analog signal. One practical partitioning of the components of the control unit 300 is to place the processing unit 302, system memory 304 and the A/D converter, if needed, within control unit formed as a control box 300. Additionally, the user interface 308 positioned on the housing of the control box 300 may have input keys 316 where, for example, commands are input for the desired through-put of pre-cut thermoplastic blocks 1000, and a display 318 showing various data to the user (e.g., selected through-put of the blocks, temperature reading for the electrically heated wires 24, 28, etc.).

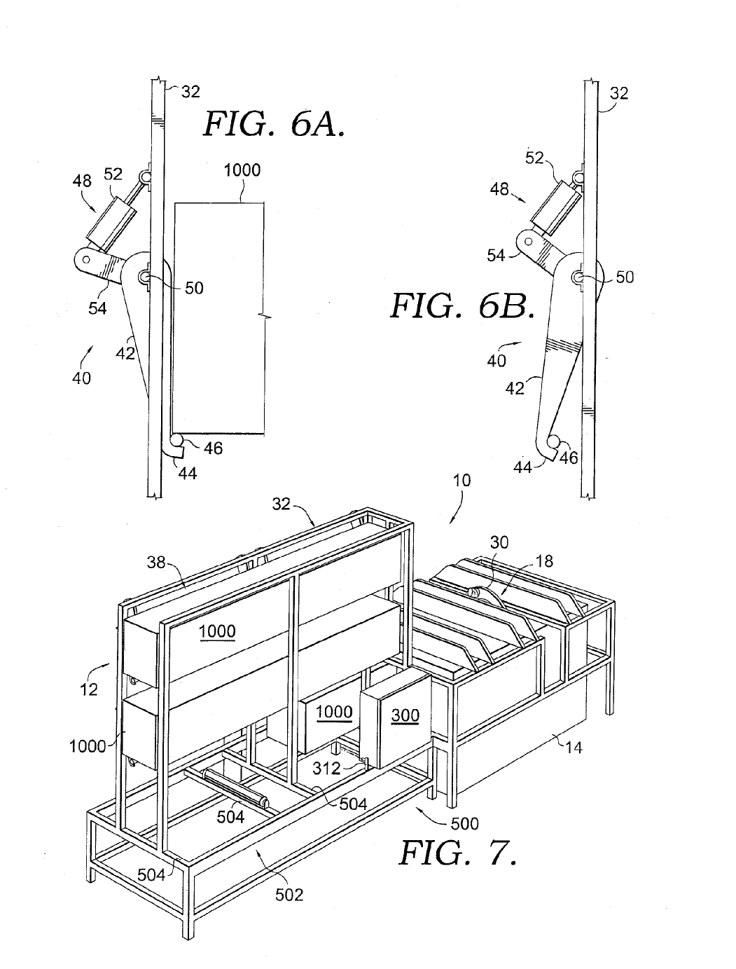

The block magazine 12, best seen in FIGS. 1 and 3, has a magazine frame 32 including vertical members 34 and upper cross-members 36 interconnecting the vertical members 34 to define a channel 38 into which may be placed thermoplastic blocks 1000. The magazine frame 32 is supported by the system frame 500. The block magazine 12 includes at least two rows of block indexing mechanisms 40 that stack the thermoplastic blocks 1000 within the channel 38 prior to being fed into the Cutting mechanism 16. Each block indexing mechanism 40 is shown in particular detail in FIGS. 6A and 6B, and includes swing arms 42 pivotably mounted with the magazine frame 32, a support bar 46 extending between adjacent swing arms 42, and a rotation control mechanism 48 to cause the swing arms to selectively rotate in one of two directions. Each swing arms 42 has a lower hook 44 for engaging the support bar 46.

One rotation control mechanism 48 may be provided for each swing arm 42, or preferably, multiple swing arms 42 are rigidly connected together through one or more rods 50, such that only one rotation control mechanism 48—rigidly connected with the rod 50—may be needed per pair of swing arms 42. Pivotable mounting of the swing arms 42 to the magazine frame 32 may be through the rods 50, which are pivotably mounted to mounting plates 51affixed to the frame 32, as seen in FIG. 3. The rotational control mechanism 48 preferably takes the form of an air or pneumatic cylinder 52 pivotably mounted on one end with the magazine frame 32 and on an opposed end with a linkage 54 that is fixedly mounted with the rod 50.

In the extended position shown in FIG. 6A, the control mechanism 48 rotates the swing arms 42 to a first position where the support bar 46 underlies the thermoplastic block 1000 stacked thereon and supports the block. When the system 10 senses (e.g., through optical sensor 312) that the cutting mechanism 16 is ready to accept a new thermoplastic block 1000, the control unit 300 instructs the rotational control mechanism 48 to rotate to the swing arms 42 to the second position shown in FIG. 6B. At the second position, the support bar 46 is no longer positioned under the block 1000, allowing block 1000 to fall by the force of gravity either to a lower-mounted block indexing mechanism 40′ or onto a platform 502 of the system frame 500 for positioning of the block 1000 for feeding into the cutting mechanism 16. After the swing arms 42 have been in the second position for a certain amount of time, the arms return to the first position to accept another thermoplastic block 1000 dropped from one block indexing mechanism 40 immediately thereabove.

The system frame platform 502 has cross-members 504 that support a thermoplastic block 1000 being fed into the cutting mechanism 16, as shown in FIG. 7, and drive rollers 56 of the driving mechanism 20 that perform such feeding or driving of the blocks. The cross-members 504 also support the magazine frame 32 and interconnect longitudinal members 506 that are supported by vertical and perpendicular bracing sub-frame members 508. The system frame platform 502 and/or the sub-frame members 508 may be rigidly connected with a support frame section 510 that supports the cutting mechanism 16 and the wrapping mechanism 18, as well as the housing 14 that encloses the cutting mechanism 16 and some components of the driving mechanism 20. The particular configuration of the support frame section 510 is a matter of design choice and may depend on the loads produced by, and induced upon, the cutting mechanism 16, wrapping mechanism 18 and at least partially the driving mechanism 20.

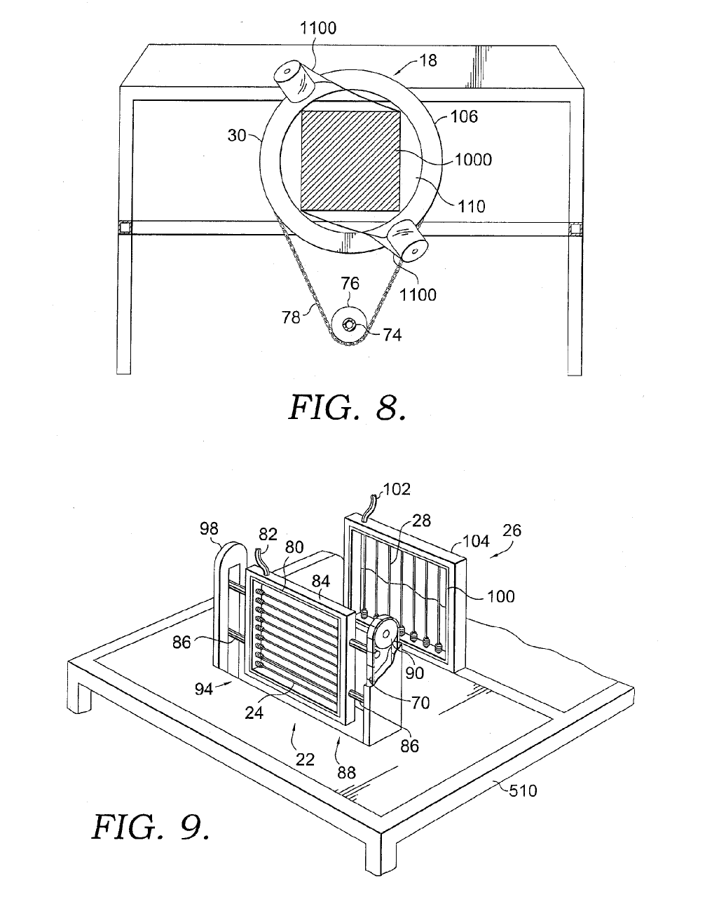

The driving mechanism 20, as seen in FIG. 3, includes the drive rollers 56 which may interconnected by a first drive chain or belt 58, and a first motor 60 which provide output torque necessary to drive the belt 58. In a preferred arrangement, at least upper and lower transversely-aligned rollers 62 are drive rollers, and vertically-aligned rollers 64 spaced near opposing ends 66 of the transverse rollers 62, as seen in FIGS. 2 and 3, may be drive rollers driven by the first motor 60 in a similar fashion or may simply be guide rollers not driven by the motors 60 but positioned simply to keep the thermoplastic blocks 1000 between the upper and lower transverse drive rollers 62 and substantially maintaining the original geometric form of the uncut blocks 1000 as the blocks are being cut and wrapped. A second motor 68 of system 10 drives a second drive belt 70 that oscillates the first cutting harp 22 vertically up and down to create the sinusoidal wave pattern as a first cut 1004 of the thermoplastic block 1000 (seen in FIG. 4) as the block is driven through the harp by the drive rollers 56. Still further, a third motor 72 of system 10 is provided and has an output shaft 74 to transfer torque to a gear 76 that drives a third drive belt 78 to induce rotation of the rotating strap wrapper 30 to dispense strapping material 1100, as shown in FIG. 8. The first motor 60 of the driving mechanism 20, and the second and third motors 68 and 72, respectively, are directly controlled by the control unit 300. However, those of skill in the art will appreciate that other motor and drive belt arrangements may be contemplated for driving thermoplastic blocks 1000 through the system 10, and for generating the oscillating motion of the first cutting harp 22 and rotation of the strap wrapper 30.

The first cutting harp 22 is shown in more detail in FIG. 9. The horizontally oriented electrically heated wires 24 are connected with a conductive subframe 80 that delivers, from wires 82 connected with an electrical source, an electrical current value that is established by the control unit 300. Because the heated wires 24 are resistive wires (as are the heated wires 28 of the second cutting harp 26), the electrical current value is selected to give the wires a certain temperature that is necessary to efficiently and smoothly cut through the thermoplastic block 1000 fed therethrough at a certain speed also established by the control unit 300. The conductive subframe 80 may be surrounded by a insulative outer frame 84 that has mounting rods 86 extending therefrom which are affixed on ends thereof with the second drive belt 70. Thus, as the second drive belt 70 is repeatedly moved in opposite directions by the second motor 68, the first cutting harp 22 moves with the belt 70 and oscillates vertically up and down. The first cutting harp 22 has a drive side 88 where the second drive belt 70 engages with upper and lower gears 90 rotatably mounted within a first track 92, and a follower side 94 where rollers are rotatably mounted with the mounting rods 86 and move within a second track 98, to guide the vertical motion of the first cutting harp 22.

The vertically oriented electrically heated wires 28 of the second cutting harp 26 are likewise connected with a conductive subframe 100 delivering, via wires 102, an electrical current value established by the control unit 300. An insulative outer frame 104 may surround the conductive subframe 100 and is mounted with the support frame section 510. As the thermoplastic block 1000 having received a first cut pattern from the first cutting harp 22—to divide the block into vertically stacked layers—is driven through the second cutting harp 26, a second cut 1006 is induced on the block by the vertical wires 28 in a series of vertical planes to further section the block. For example, the vertically stacked sections of the thermoplastic block 1000 having a sinusoidal wave pattern created by the first cut 1004 are further divided into more narrow, longitudinal wave sections, or waveform strips 1002, by the second cut 1006.

The rotating wrapper 30 is shown in more detail in FIGS. 3 and 8. The wrapper 30 is comprised of a ring 106 rotatably mounted to the support frame section 510, and two or more arms 108 extending at an angle from the rotating ring 30 for mounting thereon a roll of wrapping material 1100, such as plastic film in sheet form. An open central region 110 of the ring 106 allows the thermoplastic blocks 1000 to be driven therethrough to exit the system 10. Each arm 108 has a retaining bracket (not shown) to hold the strapping material roll on the arm while allowing the roll to freely rotate thereon. The wrapping material 1100 is initially extended between the arms 108, which are preferably are configured to position the rolls of wrapping material 1100 at diametrically opposed positions circumferentially around and with respect to the ring 106, to wrap the thermoplastic block 1000 in two directions. This positioning of the arms 108 also causes the dispensed wrapping material 1100 to compress the pre-cut block at opposed locations, thereby balancing the compressive forces to minimize distortion of the block and facilitate maintaining the original geometric form of the block while the wrapping is being applied. Because of the opposing compression, the waveform strips 1002 interlock with one another to minimize any sliding of the strips apart from one another.

As seen in FIG. 8, once the thermoplastic block 1000 is driven into the path of the wrapping material 1100, the material wraps around the perimeter of the block in film sheets of a specific width, with each arm 108 dispensing material in alternating rows around the block such that the film row at least slightly overlaps with the previous row. The speed at which the drive rollers 56 move the block 1000, as well as the speed of rotation of the ring 30, may also be optimized to ensure proper overlapping between film rows. In this way, the wrapping material 1100 retain the sectioned block in substantially the original geometric shape of the uncut thermoplastic block 1000.

In use, the cutting and wrapping system 10 first receives uncut thermoplastic blocks 1000 within the channel 38, with one block stacked onto each of the block indexing mechanisms 40, 40′. The user may make selections on the user interface 308, such as the desired through-put of pre-cut thermoplastic blocks 1000, and then selects to start the process. The optical sensor may sense whether a thermoplastic block is present on the system frame platform 502 to be fed into the cutting mechanism 16. If no Thermoplastic block 1000 is present, the control unit 300 then instructs the rotation control mechanism 48 of the lowermost block indexing mechanism 40′ to move the swing arms 42 to the position shown in FIG. 6B, thereby allowing the thermoplastic block 1000 stacked thereon to fall onto the platform 502. Then, the mechanism 48 moves the swing arms 42 back to the first position shown in FIG. 6A where a higher-mounted block indexing mechanism 40 may then release another thermoplastic block 1000 to fall onto the support bar 46 of the lowermost mechanism 40′. The drive mechanism 20, through the transversely-aligned rollers 62 and the vertically-aligned rollers 64, at least one group of which is driven by first motor 60, feed the thermoplastic blocks 1000 through the oscillating first cutting harp 22 and the stationary second cutting harp 26 while guiding the block forward and providing dimensional stability thereto such that the cut sections substantially do not separate from one another. User selections on the interface 308 regarding the desired sinusoidal pattern to be cut (e.g., the height of the wave pattern) and the through-put desired cause the control unit 300 to vary the frequency of vertical oscillation, as well as the vertical amplitude, of the first cutting harp 22. As the pre-cut thermoplastic block 1000 approaches the rotating wrapper 30 being driven therethrough by the drive mechanism 20, the wrapping material 1100 or film spinning relative to an axis of the rotating ring 106 contacts the perimeter of the block and dispenses film sheets in essentially diagonal rows around the block (the rows being diagonal because the block is always moving through the ring 106). If the user desires a certain degree of overlap in adjacent rows of dispensed film around the pre-cut thermoplastic block 1000, selections on the user interface 308 cause the control unit 300 to set a certain speed of rotation of the ring 106 relative to the through-put of blocks through the system 10. For example, if more overlap of the wrapping film is desired, the rotational speed of the ring 106 may be increased for a specific Thermoplastic block 1000 throughput value. The pre-cut and wrapped thermoplastic block 1000 that is then formed into waveform strips 1002 may then be put through another cutting mechanism (not shown) to cut the wrapped sections 1002 transversely to the cutting performed by the second cutting harp 26 to form sinusoidal waveform pellets that may be used as packaging filler, or for other uses.

As can be seen, the cutting and wrapping system 10 of the present invention provides automation to the process of cutting and packaging thermoplastic blocks 1000 in substantially the original geometric form of the uncut block, such that only one additional cutting is necessary to form the final pellet product used as packaging filler. It may be desired in certain circumstances to create pre-cut block sections 1002 with varying shapes other than the sinusoidal waveform, such that the first cutting harp 22 may oscillate or otherwise move in a more irregular pattern, or still further, the second cutting harp 26 may be configured to be movable during the cutting process. In another exemplary modification of the system 10 as described above, the alignment of the electrically heated wires 24, 28 of the first and second cutting harps 22, 26, respectively, may be reversed, such that the first cutting harp 22 has vertically-aligned wires 24 and the second cutting harp 26 has horizontally-aligned wires, to generate a cut pattern in the Thermoplastic block 1000 orthogonal to the cuts shown in FIG. 4.

Since certain changes may be made in the above system and methods without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A system for cutting blocks of synthetic material, comprising:
a frame;
a block magazine mounted with the frame for sequentially positioning the synthetic material blocks relative to the frame;
a cutting mechanism mounted with the frame for cutting synthetic blocks into sections and maintaining the sections substantially in the original geometric form of the synthetic block; and
a driving mechanism mounted with the frame for sequentially driving the synthetic blocks positioned by the block magazine through the cutting mechanism.

2. The system of claim 1, wherein the synthetic material comprises a thermoplastic material.

3. The system of claim 2, wherein the thermoplastic material is at least one material selected from the group consisting of polystyrene, polystyrene/polypropylene compounds and polystyrene/polyethylene compounds.

4. The system of claim 1, wherein the block magazine comprises:
at least two rows of block indexing mechanisms, each mechanism including,
at least two swing arms pivotably mounted with the frame,
a rotation control mechanism for selectively rotating the swing arms relative to the frame, and
a support bar extending between the at least two swing arms for supporting a synthetic block thereon when the swings arms are in a first position.

5. The system of claim 1, wherein the cutting mechanism comprises:
a first cutting harp including a series of heated wires spaced from one another; and
means for oscillating the first cutting harp.

6. The system of claim 5, wherein the series of heated wires of the first cutting harp are horizontally aligned and equally spaced, and the means for oscillating oscillates the first cutting harp in a vertical plane.

7. The system of claim 5, further comprising a second cutting harp including a series of vertically aligned and equally spaced heated wires.

8. The system of claim 5, further comprising a control means to selectively control at least one of:
the speed at which the driving means drives the synthetic blocks through the cutting mechanism;
the frequency and amplitude of the oscillation of the first cutting harp; and the temperature at which the heated wires are maintained.

9. The system of claim 1, further comprising a wrapping mechanism for maintaining the sections of at least one synthetic block together in substantially the original geometric form of the block, the wrapping mechanism including:
a ring having an open central region and rotatably mounted onto the frame to surround the perimeter of the synthetic block cut into sections being driven through the central region; and
at least two arms projecting from the ring, each arm configured to rotatably support thereon a roll of wrapping material dispensed onto and thereby wrapped around the synthetic block cut into sections as the ring rotates and the sections are driven through the central region of the ring, to thereby secure the sections together.

10. The system of claim 9, wherein the at least two arms comprises two arms configured to position the wrapping material at diametrically opposed positions with respect to the ring so that the dispensed wrapping material compresses the pre-cut block at opposed locations to thereby minimize distortion of the block and facilitate maintaining the original geometric form of the block while the wrapping is being applied.

11. The system of claim 9, further comprising a control means to selectively control at least one of:
the speed at which the driving mechanism drives the synthetic blocks through the cutting mechanism; and
the rate of rotation of the ring;
whereby the degree of overlapping of adjacent rows of strapping material wrapped around the synthetic block cut into sections may be selected.

12. A system for cutting and wrapping blocks of synthetic material, comprising:
a block magazine having a frame and including at least two indexing mechanisms each including:
one or more swing arms pivotably mounted with the frame;
a support bar extending along the one or more swing arms for supporting a synthetic block thereon when the one or more swings arms are in a first position; and
a rotation control mechanism for selectively rotating the swing arms relative to the frame, the rotation control mechanism being mounted with the frame and coupled with the one or more swing arms to move the one or more arms from a first position where a synthetic block is supported on the support bar to a second position where the support bar does not provide support for the synthetic block such that the synthetic block falls onto one of a lower-mounted block indexing mechanism or a block feeding platform;
a cutting mechanism for cutting the synthetic blocks into sections;
a wrapping mechanism for maintaining the sections of at least one synthetic block together in substantially the original geometric form of the block; and
a driving mechanism for sequentially driving the synthetic blocks positioned by the block magazine through the cutting mechanism and then through the wrapping mechanism.

13. The system of claim 12, wherein the cutting mechanism, the wrapping mechanism and the driving mechanism are each mounted onto a system frame coupled with the block magazine.

14. The system of claim 13, wherein the cutting mechanism comprises:
a first cutting harp including a series of horizontally aligned heated wires; means for vertically oscillating the first cutting harp; and
a second cutting harp including a series of vertically aligned heated wires.

15. The system of claim 13, wherein the wrapping mechanism comprises:
a ring having an open central region and rotatably mounted onto the system frame to surround the perimeter of the synthetic block cut into sections being driven through the central region; and
at least two arms projecting from the ring, each arm configured to rotatably support thereon a roll of wrapping material dispensed onto and thereby wrapped around the synthetic block cut into sections as the ring rotates and the sections are driven through the central region of the ring, to thereby secure the sections together.

16. A system for cutting and wrapping blocks of thermoplastic material, comprising: a frame;
a cutting mechanism mounted with the frame for cutting thermoplastic blocks into sections and maintaining the sections substantially in the original geometric form of the thermoplastic block;
a wrapping mechanism for maintaining the sections of at least one thermoplastic block together in substantially the original geometric form of the block; and
a driving mechanism mounted with the frame for sequentially driving the thermoplastic blocks positioned by the block magazine through the cutting mechanism and then through the wrapping mechanism.

17. The system of claim 16, wherein the cutting mechanism comprises:
a first cutting harp including a series of horizontally aligned heated wires; means for vertically oscillating the first cutting harp; and
a second cutting harp including a series of vertically aligned heated wires.

18. The system of claim 16, wherein the wrapping mechanism comprises:
a ring having an open central region and rotatably mounted onto the frame to surround the perimeter of the thermoplastic block cut into sections being driven through the central region; and
at least two arms projecting from the ring, each arm configured to rotatably support thereon a roll of wrapping material dispensed onto and thereby wrapped around the thermoplastic block cut into sections as the ring rotates and the sections are driven through the central region of the ring, to thereby secure the sections together.

19. The system of claim 18, wherein the at least two arms comprises two arms configured to position the wrapping material at diametrically opposed positions with respect to the ring so that the dispensed wrapping material compresses the pre-cut block at opposed locations to thereby minimize distortion of the block and facilitate maintaining the original geometric form of the block while the wrapping is being applied.

20. A method of manufacturing pre-cut blocks of synthetic material such that the synthetic material blocks are formed into sections which are maintained substantially in the original geometric form of the respective synthetic material block, the method comprising the steps of:
driving a synthetic material block through a cutting mechanism mounted on a frame to cut the block into a number of sections, the cutting mechanism including: a first cutting harp including a series of spaced heated wires; means for oscillating the first cutting harp; and
a second cutting harp including a series of spaced heated wires oriented at an angle to the series of spaced heated wires of the first cutting harp;
driving the synthetic material block cut into sections through a wrapping mechanism; and
simultaneous with driving the synthetic block cut into sections, wrapping the synthetic block sections with a rotating strap wrapper, the strap wrapper including:
a ring having an open central region and rotatably mounted onto the frame the frame configured to surround the perimeter of the synthetic block sections being driven through the central region; and
a pair of arms projecting from the ring, each arm configured to rotatably support thereon a roll of wrapping material dispensed onto and thereby wrapped around the synthetic block sections as the ring rotates and the sections are driven through the central region of the ring, to thereby secure the sections together;
wherein the pair of arms are configured to position the wrapping material at diametrically opposed positions with respect to the ring so that the dispensed wrapping material compresses the pre-cut block at opposed locations to thereby minimize distortion of the block and facilitate maintaining the original geometric form of the block while the wrapping is being applied.

21. The method of claim 20, further comprising:
sequentially positioning the synthetic material blocks with respect to the cutting mechanism with a block magazine, the block magazine comprising at least two rows of block indexing mechanisms each movable between a first position where one synthetic block is supported thereon and a second position where the synthetic block is not supported such that the synthetic block falls onto one of a lower-mounted block indexing mechanism or a block feeding platform for driving the synthetic block through the cutting mechanism.

22. A method of manufacturing pre-cut blocks of synthetic material such that each synthetic material block is formed into sections which are maintained substantially in the original geometric form of the respective synthetic material block, the synthetic blocks undergoing cutting by a cutting mechanism, the method comprising the steps of:
sequentially positioning the synthetic material blocks with respect to the cutting mechanism with a block magazine, the block magazine comprising at least two rows of block indexing mechanisms each movable between a first position where one synthetic material block is supported thereon and a second position where the synthetic block is not supported such that the synthetic material block falls onto one of a lower-mounted block indexing mechanism or a block feeding platform for positioning the synthetic material block prior to cutting by the cutting mechanism;
driving the synthetic material block positioned on the block feeding platform through the cutting mechanism mounted on a flame to cut the block into a number of sections, the cutting mechanism forming the sections as longitudinal strips; and driving the synthetic material block cut into sections through a wrapping mechanism that circumscribes the perimeter of the synthetic material block sections and applies wrapping material therearound to secure the sections together.
